(19) United States
(12) Patent Application Publication
(10) Pub. No.: US 2015/0374123 A1
(43) Pub. Date: Dec. 31, 2015

(54) DRIVE DEVICE FOR A MOVABLE FURNITURE PART

(71) Applicant: Julius Blum GmbH, Hoechst (AT)

(72) Inventors: Christof GOETZ, Lustenau (AT); Ingo GASSER, Hoechst (AT); Hermann HAEMMERLE, Lustenau (AT)

(21) Appl. No.: 14/844,460

(22) Filed: Sep. 3, 2015

Related U.S. Application Data
(63) Continuation of application No. PCT/AT2014/000055, filed on Mar. 26, 2014.

(30) Foreign Application Priority Data
Apr. 12, 2013 (AT) A 296/2013

(51) Int. Cl. A47B 88/04; E05B 65/46; A47B 88/16

(52) U.S. Cl. CPC A47B 88/0477; A47B 88/16; A47B 88/047; E05B 65/462

(57) ABSTRACT

The invention relates to a drive device for a furniture part which can be displaced in a furniture body, comprising an ejection device which can be locked in a locked position, said ejection device being used to move the moveable furniture part from a closed position into an open position. The ejection device can be unlocked by pushing the movable furniture part so that it moves into a pushed-in position which is beyond the closed position in the closing direction, this enables the ejection device to move the moveable furniture part in the opening direction; the moveable furniture part can also be moved from the closed position into the open position by pulling said moveable furniture part, the ejection device remaining in the locked position when opened by pulling. Said drive device also comprises a coupling device for coupling the drive device to the moveable furniture part or to the furniture body, when ejecting the moveable furniture part by means of the ejection device, the coupling device assumes the coupling position, when opening by pulling, the coupling device can be freely moved with respect to the ejection device.

The invention concerns a drive device for a furniture part moveable in a furniture carcass, comprising an ejection device lockable in a locked position for moving the moveable furniture part from a closed position into an open position, wherein the ejection device is unlockable by over-pressing the moveable furniture part into an over-pressing position which is behind the closed position in the closing direction, whereby the moveable furniture part is moveable by the ejection device in the opening direction, wherein the moveable furniture part is also moveable from the closed position into an open position by pulling on the moveable furniture part, wherein the ejection device remains in the locked position upon opening by pulling, and a coupling device for coupling the drive device to the moveable furniture part or to the furniture carcass. The invention further concerns an article of furniture having such a drive device.

So-called touch latch mechanisms have already been known for many years in the furniture fitting industry, in which an ejection device is unlocked by pressing against the moveable furniture part which is in the closed position, whereupon the moveable furniture part (for example a drawer or a furniture flap) is ejected in the opening direction.

In simple touch latch mechanisms of a different general kind the ejection device is disposed anywhere on the furniture carcass and ejects the moveable furniture part at least during the first opening travel. There is no coupling device for coupling the drive device to the moveable furniture part. Rather, there is only an abutment surface against which the moveable furniture part directly or indirectly bears. If, in the case of such a drive device, instead of over-pressing the moveable furniture part, the moveable furniture part is simply pulled starting from the closed position, then the moveable furniture part is lifted away from the abutment surface without triggering a movement in the drive device.

Conversely, in WO 2012/149587 A1 which is also of a different general kind, a coupling device remains in a coupling position upon ejection of the moveable furniture part whereas however the locking device with the cardioid-shaped guide path is no longer in the locking position when opening the moveable furniture part by pulling. Rather, there is provided an evasion passage by which the locking pin can evasively pass through the “heart” of the cardioid when opening by pulling. The locking position is therefore preserved upon opening by pulling.

In WO 2011/015663 A1 which relates to a different general kind of device the coupling position between the drive device and the moveable furniture part or furniture carcass is also maintained in the same fashion upon opening by pulling, but unlocking of the lockable ejection device is implemented both upon unlocking by over-pressing and also upon unlocking by pulling.

In comparison, WO 2009/114886 A1 disclosing a device of the general kind set forth herein discloses a kind of overload protection device in which the ejection device remains in a locking position upon opening by pulling (see FIG. 30c). The catch fork however is pivoted against the force of a spring by a pin associated with the furniture carcass whereby the drive device is no longer coupled to the furniture carcass upon opening by pulling. A disadvantage with that structure is that, upon such opening by pulling, the drive device has to be unlocked upon re-closing the furniture part so that it is only after that that the pin can be coupled to the catch element again.

Therefore the object of the present invention is to provide a drive device which is an alternative or which is improved over the state of the art. In particular the invention seeks to avoid the disadvantages of the state of the art defining the general kind of drive device involved here.

That is achieved by a drive device having the features of claim 1. In accordance therewith it is provided that the coupling device is in a coupling position upon ejection of the moveable furniture part by the ejection device, wherein the coupling device is moveable loosely with respect to the ejection device upon opening by pulling. Accordingly the coupling device remains in a coupling position at least portion-wise upon opening by pulling and the coupling device can be moveable free of a spring loading of an overload spring. In addition no unlocking has to be effected upon re-closing as when the furniture part is pushed in the components of the coupling device can be simply coupled together again.

The “loose” movement of the coupling device with respect to the ejection device can be defined in other words by stating that, upon opening by pulling, the coupling device is moveable independently of the ejection device. In still other words, the coupling device is not connected to the ejection device upon opening by pulling. In that case the coupling device can be moveable with a translatory component with respect to the drive device, wherein for example the coupling device is moveable without a spring loading in a linear portion of a guide path.

Basically it can be provided that the coupling device is in a coupling position during the entire opening travel of the moveable furniture part. It is however preferably provided that upon opening by pulling the coupling device remains in the coupling position only in a first opening travel portion which is in front of the closed position in the opening direction. In that case the first opening travel portion can be between 10 mm and 100 mm, preferably between 20 mm and 70 mm, in length.

It is particularly preferably provided for the loose movement that the coupling device has a transmission abutment, by way of which the coupling device bears against a triggering abutment of the ejection device in the closed position and in an over-pressing region between the closed position and the over-pressing position, whereas upon opening by pulling the transmission abutment lifts away from the triggering abutment or moves away therefrom so that there is no longer any contact between the transmission abutment and the triggering abutment.

In an embodiment of the invention it can be provided that the drive device has a base plate. It is particularly preferably provided in that respect that the ejection device has a preferably cardioid-shaped guide path in the base plate, an ejection slider which is moveable preferably linearly along the base plate, a locking lever mounted pivotably to the ejection slider, a locking pin mounted to the locking lever and displaceable in the guide path and an ejection force storage means fixed on the one hand to the base plate and on the other hand to the ejection slider. With such a structure basically the triggering abutment can be provided on any component, for example on the ejection slider of the ejection device. It is preferably provided however that the triggering abutment of the ejection device is on the locking lever.

In addition in a preferred embodiment of the invention it can be provided that the coupling device has a coupling slider displaceable at least portion-wise linearly in the base plate and a catch element mounted moveably, preferably pivotably, on the coupling slider, for a coupling entrainment portion arranged on the furniture carcass or on the moveable furniture part, wherein the coupling slider and the catch element are displaceable along a portion-wise linear guide path in the base plate, having an angled end portion. It is preferably provided in that case that the transmission abutment of the coupling device is provided on the coupling slider.

In order to integrate not just the function of active ejection by over-pressing into the drive device, the drive device can preferably also have a retraction device for retraction of the moveable furniture part from an open position into the closed position. For coupling the retraction device to the furniture carcass or to the moveable furniture part it can be provided in that case that the retraction device can be brought into engagement by way of a retraction catch element with a retraction entrainment portion which is separate from the coupling entrainment portion.

If the ejection device and the retraction device of the drive device form a common structural unit it is preferably provided that the retraction device can be at least portion-wise coupled to the coupling device by way of the retraction catch element and upon opening by pulling a retraction force storage means of the retraction device can be stressed along the first opening travel portion. Thus the coupling device is in the coupling position, upon retraction by the retraction device.

Basically however the retraction device and the ejection device do not have to be in the form of a structural unit. Rather, it can also often happen that a drive device according to the invention is to be retro-fitted in already existing moveable furniture parts or in extension guide assemblies. In that case for example retraction devices which have a retraction entrainment portion are already provided in the extension guide assemblies. Accordingly in that case only the ejection device has to be retro-fitted, in which case then two separate entrainment portions (retraction entrainment portion and coupling entrainment portion) are provided for making the connection or coupling between the drive device and the furniture carcass or the moveable furniture part.

Protection is also claimed for an article of furniture having a furniture carcass, a furniture part moveable relative to the furniture carcass and a drive device according to the invention for the moveable furniture part. In that respect it can in principle be provided that the drive device is disposed on the furniture carcass and a coupling entrainment portion is associated with the moveable furniture part. In a preferred embodiment however it is provided that the drive device is disposed on the moveable furniture part, wherein the coupling device has a coupling entrainment portion which is associated with the furniture carcass and which can be brought into engagement with the catch element.

Further details and advantages of the present invention are described more fully hereinafter by means of the specific description with reference to the embodiments by way of example illustrated in the drawings in which:

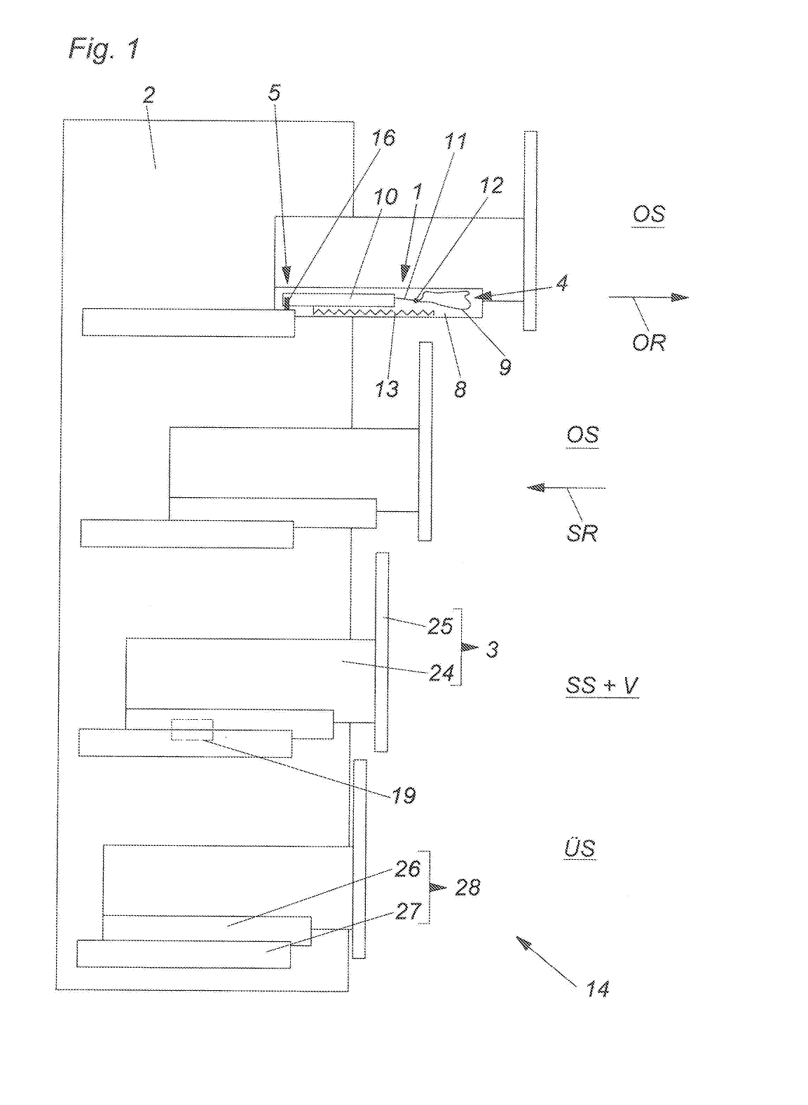

FIG. 1 diagrammatically shows an article of furniture with moveable furniture parts in various positions,

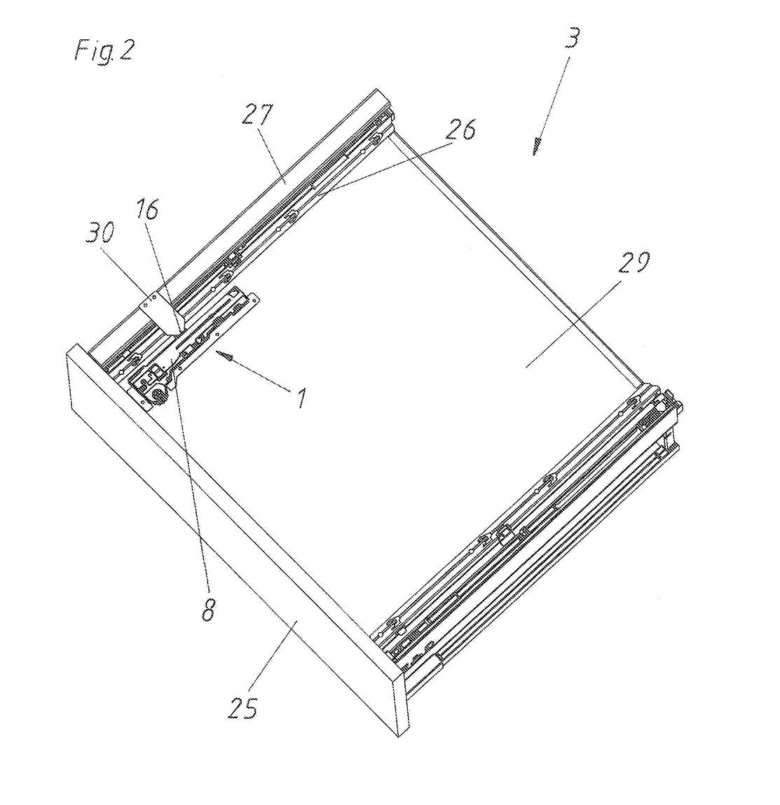

FIG. 2 shows a moveable furniture part from below with a drive device,

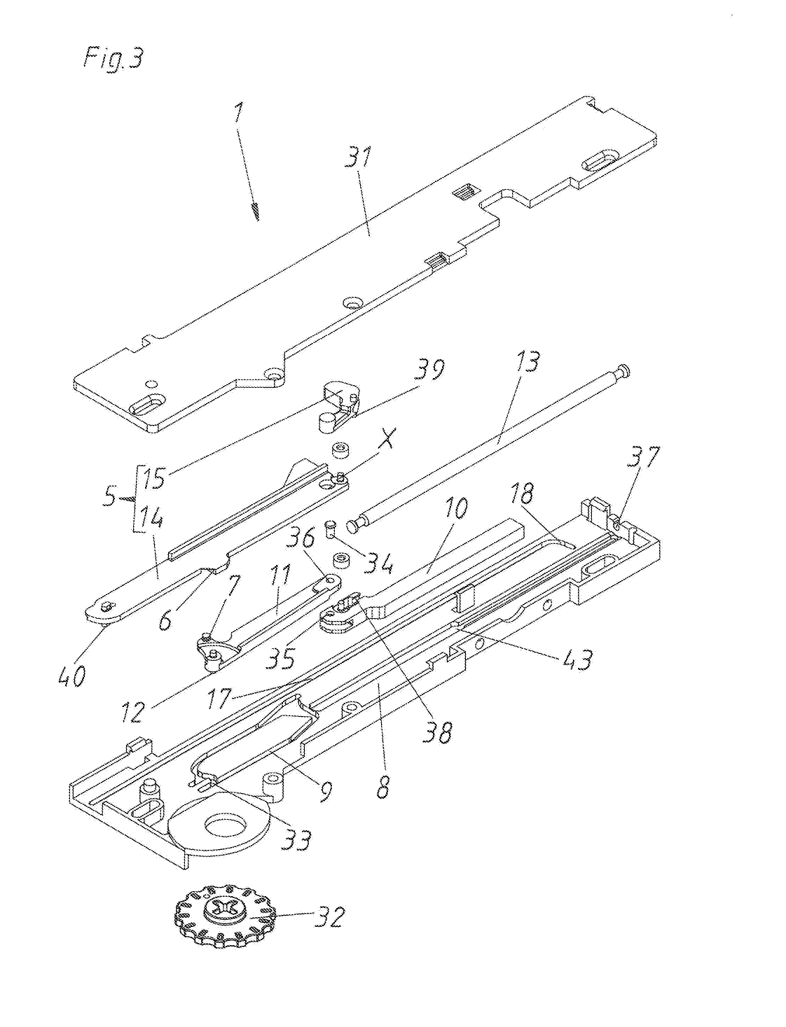

FIG. 3 shows an exploded view of a drive device,

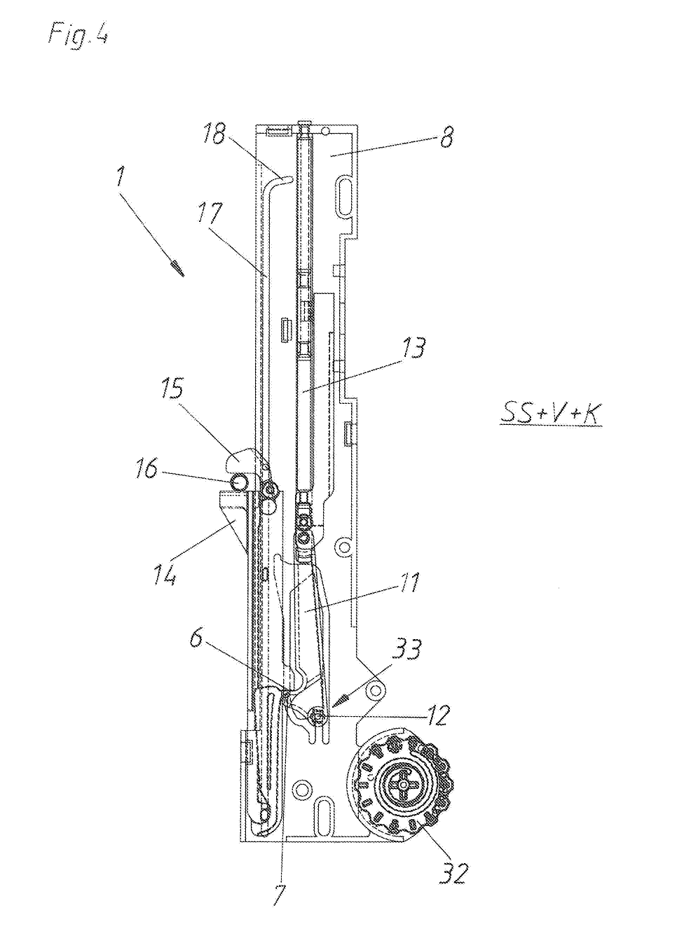

FIG. 4 shows the drive device in the closed position,

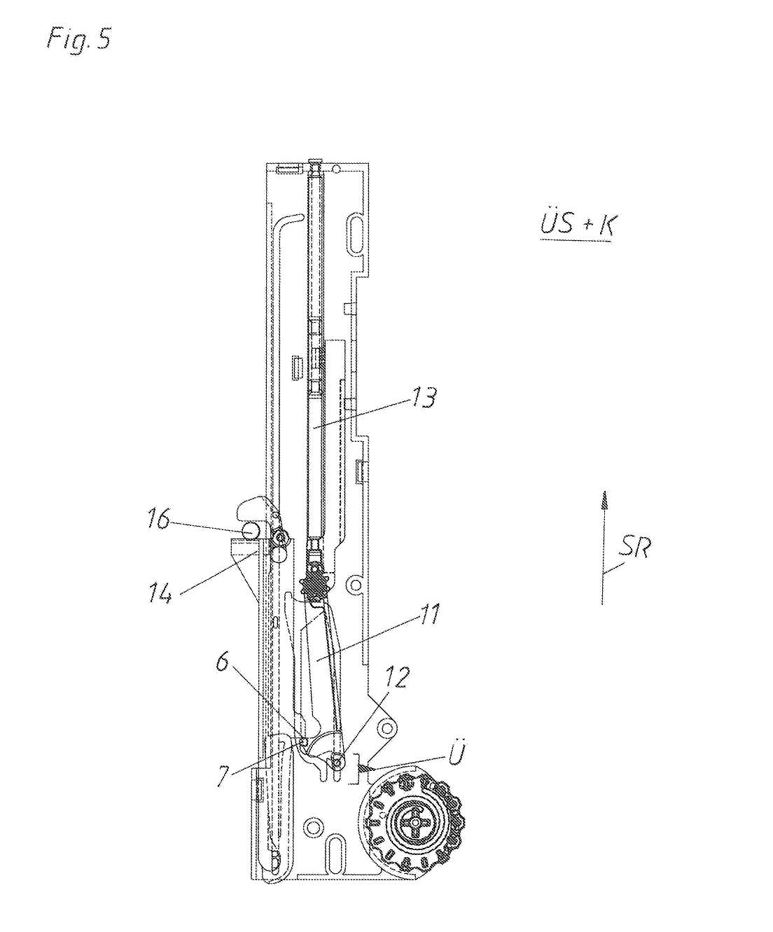

FIG. 5 shows the drive device in the over-pressing position,

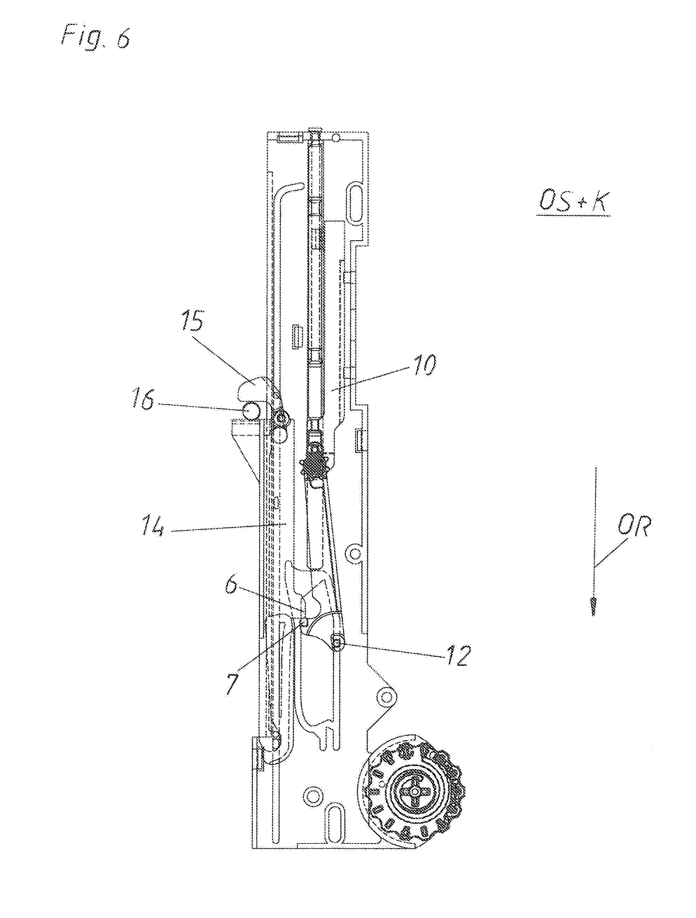

FIG. 6 shows the drive device upon ejection,

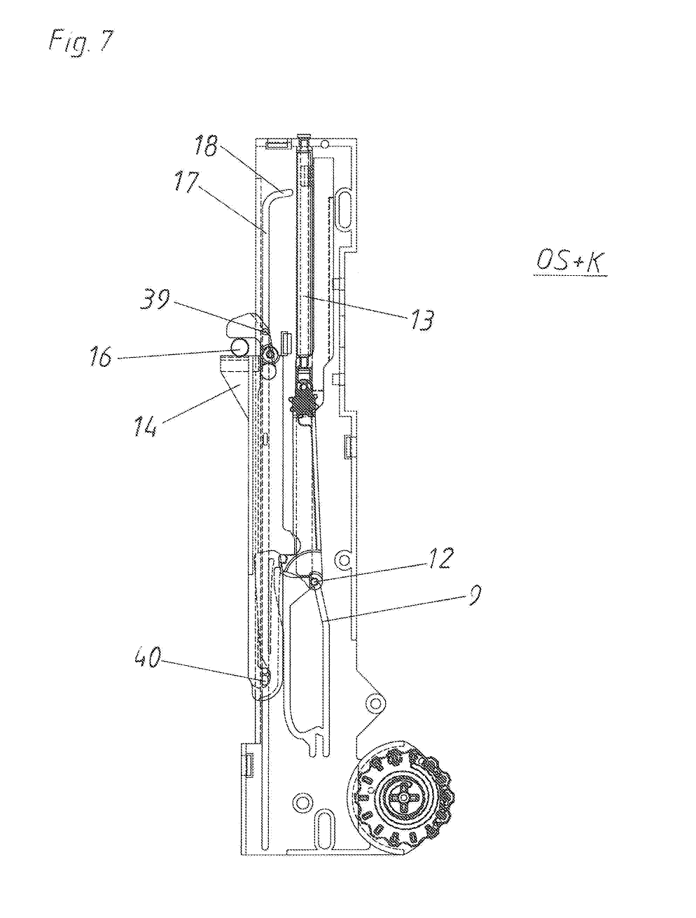

FIG. 7 shows the drive device after termination of the ejection process,

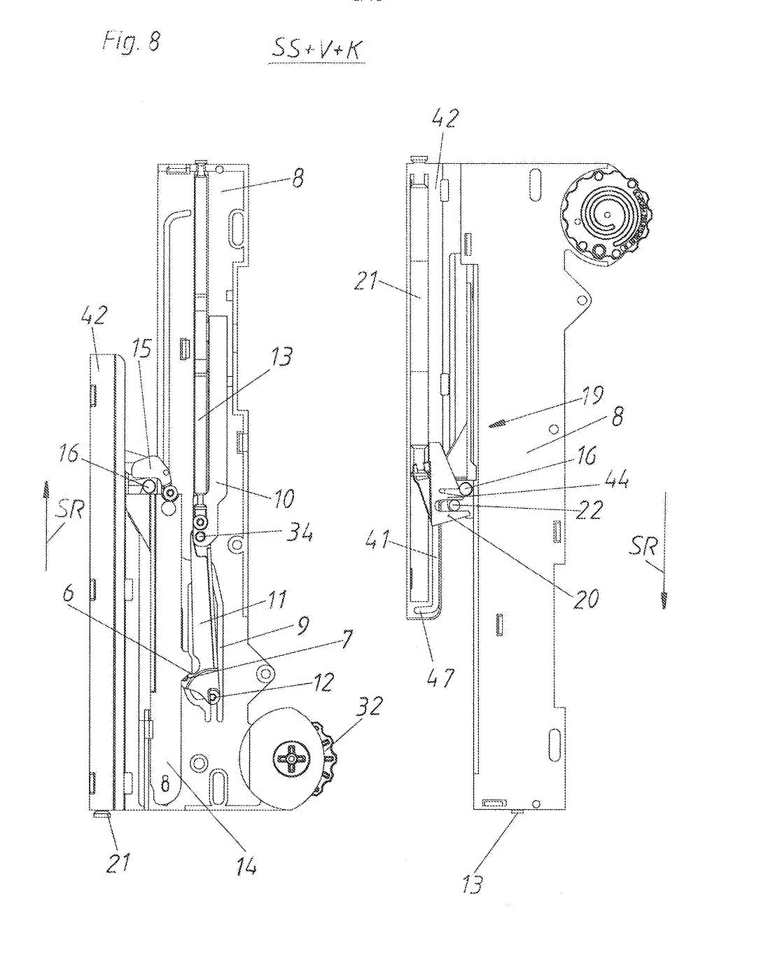

FIG. 8 shows the drive device with ejection device and retraction device in the closed position,

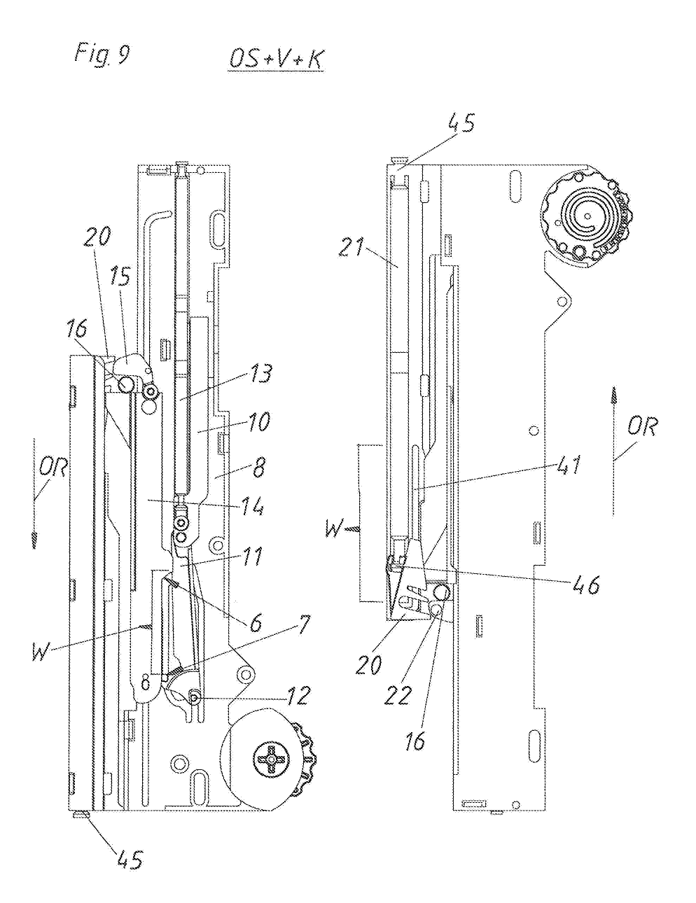

FIG. 9 shows the drive device upon opening by pulling, and

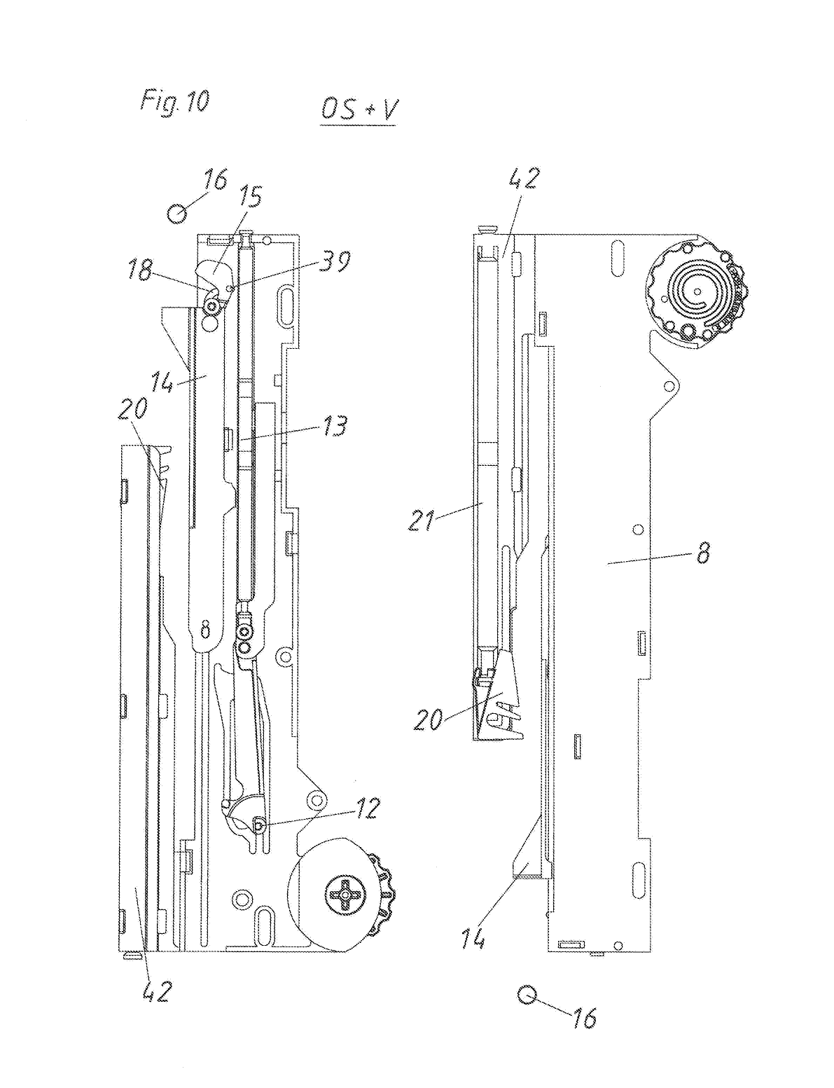

FIG. 10 shows the drive device after termination of opening by pulling.

FIG. 1 shows an article of furniture 14 comprising a furniture carcass 2 and a plurality of moveable furniture parts 3 in the form of drawers. Viewed from above downwardly the drawers are in an open position OS, then in an open position OS which is further moved in the closing direction SR, then in the closed position SS and right at the bottom in the over-pressing position ÜS. In general it is to be stated that the moveable furniture part 3 comprises a drawer container 24 and a front panel 25. Each moveable furniture part 3 is supported moveably on the furniture carcass 2 by way of an extension guide assembly 28. In that respect the extension guide assembly 28 has a drawer rail 26, a carcass rail 27 and optionally a central rail (not shown). In addition a diagrammatically indicated retraction device 19 can be provided for example between the drawer rail 26 and the carcass rail 27. The drive device 1 has an ejection device 4 which in this case is associated with the moveable furniture part 3. As essential components, the ejection device 4 has the base plate 8 fixed to the moveable furniture part 3 or to the drawer rail 26, the cardioid-shaped guide path 9 in the base plate 8, the ejection slider 10 mounted moveably on the base plate 8, the locking lever 11 mounted pivotably to the ejection slider 10, the locking pin 12 which is mounted to the locking lever 11 and which is displaceable in the cardioid-shaped guide path 9 and the ejection force storage means 13 which is braced between the ejection slider 10 and the base plate 8. In addition the ejection device 4 is coupled to the furniture carcass 2 by way of a coupling device 5 and the coupling entrainment portion 16.

That coupling entrainment portion 16 is also visible in FIG. 2, being mounted to the carcass rail 27 by way of the entrainment plate 30. The drive device 1 itself is mounted to the drawer bottom 29 of the moveable furniture part 3 by way of the base plate 8 or a cover 31.

It will be seen from the exploded view in FIG. 3 that the cardioid-shaped guide path 9 is provided in the base plate 8. In that case the guide path 9 as an important component has the latching region 33. A depth adjusting wheel 32 is also rotatably mounted on the base plate 8. The ejection slider 10 of the ejection device 4 is mounted linearly displaceably along the guide path 43 on the base plate 8. The ejection force storage means 13 which is in the form of a tension spring is braced between the ejection slider 10 and the base plate 8 by way of the spring base 37 and the spring base 38. The locking lever 11 is mounted pivotably to the ejection slider 10 by way of the rotary mounting 35, the rotary pin 34 and the rotary mounting 36. Arranged on the locking lever 11 is the locking pin 12 which is displaceable in the guide path 9 in the base plate 8. The triggering abutment 7 is also provided on the locking lever 11. In matching relationship therewith the transmission abutment 6 is provided on the coupling slider 14. The catch element 15 is mounted pivotably to the coupling slider 14 by way of the axis of rotation X. The coupling slider 14 and the catch element 15 are mounted displaceably by way of the guide pins 39 and 40 in the guide path 17 in the base plate 8. That guide path 17 has an angled end portion 18 for the guide pin 39. The coupling slider 14 and the catch element 15, jointly with a coupling entrainment portion 16 which is not shown in FIG. 3, form the coupling device 5. The drive device 1 is closed with a cover 31 which can be fixed to the base plate 8.

FIG. 4 shows the drive device 1 in a position when the moveable furniture part is in the closed position SS. At the same time in that closed position SS, the lockable ejection device 4 is disposed in a locked position V as the locking pin 12 mounted to the locking lever 11 is in the latching region 33 of the guide path 9. The ejection force storage means 13 is stressed in that locked position V. In addition the coupling device 5 is in a coupling position K in which the coupling entrainment portion 16 associated with the furniture carcass 2 is held or caught between the coupling slider 14 and the catch element 15. In that closed position SS, there is contact between the transmission abutment 6 on the coupling slider 4 and the triggering abutment 7 on the locking lever 11.

If now, starting from that position shown in FIG. 4, a pressing force is applied to the moveable furniture part 3 in the closing direction SR then the moveable furniture part 3 moves into an over-pressing region Ü between the closed position SS and the over-pressing position ÜS, as shown in FIG. 5. As the coupling entrainment portion 16 is fixed with respect to the carcass, when the furniture part 3 is over-pressed, the base plate 8 of the drive device 1 is moved in the closing direction SR relative to the coupling entrainment portion 16. As however the coupling entrainment portion 16 is coupled to the coupling device 5 the coupling slider 14 and by way of the transmission abutment 6 and the triggering abutment 7 also the locking lever 11 are moved relative to the base plate 8 whereby the locking pin 12 on the locking lever 11 is moved out of the latching region 33 of the cardioid-shaped guide path 9.

As soon as that position is reached the ejection force storage means 13 is no longer locked and the ejection slider can move relative to the base plate 8 into the position of FIG. 6. With that movement of the ejection slider 10 the locking lever 11 and by way of the triggering abutment 7 and the transmission abutment 6 also the coupling slider 14 are also moved. As a result the drive device 1 bears by way of the coupling device 5 against the coupling entrainment portion 16 and is in an open position OS in which the coupling device 5 is always still in the coupling position K.

At the end of the ejection movement the drive device 1 is in the position shown in FIG. 7 in which the moveable furniture part 3 is still in an open position OS and the coupling device 5 also still remains in the coupling position K. To provided for uncoupling of the coupling device 5 the moveable furniture part 3 is further moved in the opening direction OR either by momentum or by pulling until the catch element 15 passes by way of its guide pin 39 into the angled end portion 19 of the guide path 17 so that the coupling entrainment portion 16 is no longer caught between the coupling slider 14 and the catch element 15. The ejection force storage means 13 is relieved of stress in the position shown in FIG. 7.

Such a drive device 1 as shown in FIGS. 1 through 7 can be easily retro-fitted in an existing moveable furniture part 3. In that case a retraction device 19 can already be disposed for example in the region of the extension guide assembly 28.

In order however to provide a drive device 1 in the form of a structural unit having an ejection device 4 and a retraction device 19 attention is directed to the embodiment shown in FIGS. 8 through 10. FIGS. 8 through 10, in contrast to FIGS. 4 through 7, describe and illustrate opening by pulling, wherein naturally such opening by pulling also correspondingly applies for FIGS. 4 through 7. Conversely unlocking by over-pressing as shown in FIGS. 4 through 7 correspondingly also applies for FIGS. 8 through 10.

In FIG. 8 the moveable furniture part 3—like also in FIG. 4—is in the closed position SS. In that case the ejection device 4 is in the locked position V in which the locking pin 12 is locked in the latching region 33 of the guide path 9. As can be seen from the right-hand view in FIG. 8 the rear view of the drive device 1 is shown, with the base plate 8 being connected to a base plate member 42 of the retraction device 19. As essential components the retraction device 19 has the base plate member 42, the retraction catch element 20, the retraction guide path 41 in the base plate member 42 for the retraction guide element 20 and the retraction force storage means 21 which is fixed on the one hand to the base plate member 42 and on the other hand to the retraction catch element 20. That retraction force storage means 21 is in the form of a tension spring. As a further important component for the retraction device 19, disposed on the catch element 15 of the coupling device 5 is the retraction entrainment portion 22 which is held in the catch region of the retraction catch element 20. The coupling entrainment portion 16 which is separate from that retraction entrainment portion 22 is held between the catch element 15 and the coupling slider 14. If—as shown in FIG. 5—a pressing force is applied to the moveable furniture part 3 in the closing direction SR the elastic arm 44 of the retraction catch element 20 yields and allows movement of the catch element 15 together with the retraction entrainment portion 22 relative to the retraction catch element 20 in opposite relationship to the closing direction SR as the retraction catch element 20 is already in its end abutment condition in the retraction guide path 41. That end abutment condition is necessary to also stop the moveable furniture part 3 in the closed position upon being retracted by the retraction device 19, and to not move it further into an over-pressing position ÜS. Nonetheless that movement into the over-pressing position ÜS is to be possible, the elastic arm 44 being provided precisely for that purpose.

If now the moveable furniture part 3 is not unlocked and ejected by over-pressing, as shown in FIG. 5, but opening is effected by pulling on the moveable furniture part 3, the drive device 1 moves into an open position OS as shown in FIG. 9. It will be seen in that position that the ejection device 4 is still in a locking position V. Upon opening by pulling the base plate 8 is moved in the opening direction OR relative to the coupling entrainment portion 16 which is fixed with respect to the carcass. As the coupling device 5 is coupled to the coupling entrainment portion 16 by way of the catch element 15 and the coupling entrainment portion 14 and is thus in a coupling position K the triggering abutment 7 is lifted away from the transmission abutment 6, whereby upon opening by pulling the coupling device 5 moves loosely with respect to the ejection device 4. The retraction force storage means 21 is also stressed with that opening movement along the first opening travel portion W as on the one hand the spring base 45 moves by way of the base plate member 42 with the base plate 8 in the opening direction OR, but on the other hand the retraction force storage means 21 is coupled by way of the spring base 46 and the retraction catch element 20 to the retraction entrainment portion 22 provided on the catch element 15. As soon as the angled end portion 47 of the retraction guide path 41 is reached the retraction catch element 20 pivots so that the retraction catch element 20 is uncoupled from the retraction entrainment portion 22, as shown in FIG. 9. At the same time however the coupling device 5 is still in the coupling position K with the coupling entrainment portion 16. In that position as shown in FIG. 9 the retraction force storage means 21 is stressed again.

With a further movement of the moveable furniture part 3 in the opening direction OR the drive device 1 passes into the position shown in FIG. 10, in which the coupling slider 14 and in particular the catch element 15 have also reached the angled end portion 18, in which the coupling position K is cancelled, whereby the coupling entrainment portion 16 is no longer held. The ejection device 4 is still in the locked position V.

The present invention thus provides a drive device 1 in which the coupling device 5 is freely moveable upon opening by pulling in relation to the ejection device 4. In that way the ejection device 4 can remain in the locked position V upon opening by pulling. At the same time however upon closing the appropriate coupling position K of the drive device 1 is immediately restored.

1. A drive device for a furniture part moveable in a furniture carcass, comprising
an ejection device lockable in a locked position for moving the moveable furniture part from a closed position into an open position, wherein the ejection device is unlockable by over-pressing the moveable furniture part into an over-pressing position which is behind the closed position in the closing direction, whereby the moveable furniture part is moveable by the ejection device in the opening direction, wherein the moveable furniture part is also moveable from the closed position into an open position by pulling on the moveable furniture part, wherein the ejection device remains in the locked position upon opening by pulling, and
a coupling device for coupling the drive device to the moveable furniture part or to the furniture carcass,
wherein the coupling device is in a coupling position upon ejection of the moveable furniture part by the ejection device, wherein the coupling device is moveable loosely with respect to the ejection device upon opening by pulling.

2. A drive device as set forth in claim 1 wherein upon opening by pulling the coupling device remains in the coupling position in a first opening travel portion which is in front of the closed position in the opening direction.

3. A drive device as set forth in claim 2 wherein the first opening travel portion is between 10 mm and 100 mm, preferably between 20 mm and 70 mm, in length.

4. A drive device as set forth in claim 1 wherein the coupling device has a transmission abutment, by way of which the coupling device bears against a triggering abutment of the ejection device in the closed position and in an over-pressing region between the closed position and the over-pressing position.

5. A drive device as set forth in claim 1 wherein the drive device has a base plate.

6. A drive device as set forth in claim 5 wherein the ejection device has a preferably cardioid-shaped guide path in the base plate, an ejection slider which is moveable preferably linearly along the base plate, a locking lever mounted pivotably to the ejection slider, a locking pin mounted to the locking lever and displaceable in the guide path and an ejection force storage means fixed on the one hand to the base plate and on the other hand to the ejection slider.

7. A drive device as set forth in claim 4 wherein the triggering abutment of the ejection device is provided on the locking lever.

8. A drive device as set forth in claim 5 wherein the coupling device has a coupling slider displaceable at least portion-wise linearly in the base plate and a catch element mounted moveably, preferably pivotably, on the coupling slider, for a coupling entrainment portion arranged on the furniture carcass or on the moveable furniture part.

9. A drive device as set forth in claim 8 wherein the transmission abutment of the coupling device is provided on the coupling slider.

10. A drive device as set forth in claim 8 wherein the coupling slider and the catch element are displaceable along a portion-wise linear guide path in the base plate, having an angled end portion.

11. A drive device as set forth in claim 1 wherein a retraction device for retraction of the moveable furniture part from an open position into the closed position.

12. A drive device as set forth in claim 11 wherein the refraction device can be brought into engagement by way of a retraction catch element with a retraction entrainment portion which is separate from the coupling entrainment portion.

13. A drive device as set forth in claim 12 wherein the refraction device can be at least portion-wise coupled to the coupling device by way of the retraction catch element and upon opening by pulling a retraction force storage means of the retraction device can be stressed along the first opening travel portion.

14. An article of furniture having a furniture carcass, a furniture part moveable relative to the furniture carcass and a drive device as set forth in claim 1 for the moveable furniture part.

15. An article of furniture as set forth in claim 14 wherein the drive device is arranged on the moveable furniture part, wherein the coupling device has a coupling entrainment portion which is associated with the furniture carcass and which can be brought into engagement with the catch element.
